(19) United States
(12) Patent Application Publication
(10) Pub. No.: US 2014/0334465 A1
(43) Pub. Date: Nov. 13, 2014

(54) METHOD AND APPARATUS FOR PAGING BASED ON LOCATION INFORMATION OF A USER EQUIPMENT IN A CONVERGENCE NETWORK OF A PLURALITY OF COMMUNICATION SYSTEMS

(71) Applicant: LG ELECTRONICS INC., Seoul (KR)

(72) Inventors: Eunjong LEE, Seoul (KR); Jaehoon CHUNG, Seoul (KR); Hyeyoung CHOI, Seoul (KR); Heejeong CHO, Seoul (KR); Genebeck HAHN, Seoul (KR)

(73) Assignee: LG ELECTRONICS INC., Seoul (KR)

(21) Appl. No.: 14/271,998

(22) Filed: May 7, 2014

Related U.S. Application Data
(60) Provisional application No. 61/820,711, filed on May 8, 2013.

(51) Int. Cl. H04W 48/18; H04W 68/02

(52) U.S. Cl. CPC H04W 48/18; H04W 68/02
USPC 370/338; 370/328

(57) ABSTRACT

A method and apparatus for paging based on location information of a user equipment connected to a first communication system in a convergence network of a plurality of communication systems. A method for paging based on location information of a user equipment connected to a first communication system in a convergence network of a plurality of communication systems includes receiving, from a interworking entity of the second communication system, the location information of the user equipment which is in an idle mode with the second communication system; transmitting, to a first cell of the second communication system, a paging request message, wherein the first cell is selected from among a plurality of cells in a tracking area of the second communication system based on the location information.

Pursuant to 35 U.S.C. §119(e), this application claims the benefit of U.S. provisional application 61/820,711, filed on May 8, 2013, which is hereby incorporated by reference as if fully set forth herein.

### TECHNICAL FIELD

The present invention relates to wireless communication, and more particularly to a method and apparatus for paging based on location information of a user equipment in a convergence network of a plurality of communication systems.

### BACKGROUND ART

There is a multi-RAT user equipment (UE) having capability in which the multi-RAT UE can access two or more radio access technologies (RATs). In order to access a specific RAT, connection to a specific RAT can be established on the basis of a UE request, and data transmission/reception can be achieved on the basis of the UE request.

However, although the multi-RAT UE has the capability to access two or more RATs, the multi-RAT UE cannot simultaneously access multiple RATs. In other words, although a current UE has multi-RAT capability, the UE cannot simultaneously transmit and receive data through different RATs.

The conventional multi-RAT technology need not perform interworking between a WLAN and a cellular network, such that overall system efficiency is low. However, a method for solving such low system efficiency has not yet been researched and discussed.

### DISCLOSURE

### Technical Problem

An object of the present invention is to provide a method for paging based on location information of a user equipment in a convergence network of a plurality of communication systems.

An object of the present invention is to provide an entity for paging based on location information of a user equipment in a convergence network of a plurality of communication systems.

It is to be understood that technical objects to be achieved by the present invention are not limited to the aforementioned technical objects and other technical objects which are not mentioned herein will be apparent from the following description to one of ordinary skill in the art to which the present invention pertains.

### Technical Solution

To achieve these and other advantages and in accordance with the purpose of the present invention, as embodied and broadly described, in a convergence network of a plurality of communication systems, a method performed by a MME (Mobility Management Entity) of a second communication system and includes receiving, from a interworking entity of the second communication system, the location information of the user equipment which is in an idle mode with the second communication system; and transmitting, to a first cell of the second communication system, a paging request message, wherein the first cell is selected from among a plurality of cells in a tracking area of the second communication system based on the location information.

To further achieve these and other advantages and in accordance with the purpose of the present invention, in a convergence network of a plurality of communication systems, the apparatus includes a RF (Radio Frequency) module, a processor which is configured to: receive, from a interworking entity of a second communication system, the location information of the user equipment which is in an idle mode with the second communication system; and transmit, to a first cell of the second communication system, a paging request message, wherein the first cell is selected from among a plurality of cells in a tracking area of the second communication system based on the location information.

According to one embodiment, further includes transmitting, to the plurality of cells in the tracking area of the second communication system, the paging request message when a connection request message is not received from the user equipment in a reference time.

According to one embodiment, the location information is received whenever the user equipment is connected to the first communication system.

According to one embodiment, the location information is received when the MME receives a downlink notification message.

According to one embodiment, the location information is determined based on a geological location of a AP (access point) of the first communication system to which the user equipment is connected.

According to one embodiment, the first communication system is a WLAN (wireless LAN) network system, and the second communication system is a cellular system.

According to one embodiment, the interworking entity is a IWME (InterWorking Management Entity) or a eNode B.

### Advantageous Effects

According to embodiments of the present invention, a method and apparatus for paging based on location information of a user equipment in a convergence network of a plurality of communication systems can be provided.

It will be appreciated by persons skilled in the art that the effects that can be achieved with the present invention are not limited to what has been particularly described hereinabove and other advantages of the present invention will be more clearly understood from the following detailed description taken in conjunction with the accompanying drawings.

### DESCRIPTION OF DRAWINGS

The accompanying drawings, which are included to provide a further understanding of the invention, illustrate embodiments of the invention and together with the description serve to explain the principle of the invention.

FIG. 1 is a block diagram illustrating a base station (BS) and a user equipment (UE) for use in a wireless communication system.

FIG. 2 shows an exemplary overall architecture of the 3GPP LTE system.

FIG. 3 is a conceptual diagram illustrating a network structure for explaining an interworking structure between a first communication system and a second communication system.

FIG. 4 is a conceptual diagram illustrating a network structure of Wi-Fi-Cellular interworking according to embodiments of the present invention.

FIG. 5 is a conceptual diagram illustrating the method of connecting to WIFI network for a user equipment in an idle mode (UL data, UE triggered WIFI attach).

FIG. 6 is a conceptual diagram illustrating the method of connecting to WIFI network for a user equipment in an idle mode.

FIG. 7 is a conceptual diagram illustrating the method of connecting to WIFI network for a user equipment in the WIFI power saving mode.

FIG. 8 is a conceptual diagram illustrating the method of cellular paging based on the WIFI location.

### BEST MODE

Reference will now be made in detail to the preferred embodiments of the present invention, examples of which are illustrated in the accompanying drawings. The detailed description, which will be given below with reference to the accompanying drawings, is intended to explain exemplary embodiments of the present invention, rather than to show the only embodiments that can be implemented according to the present invention. The following detailed description includes specific details in order to provide a thorough understanding of the present invention. However, it will be apparent to those skilled in the art that the present invention may be practiced without such specific details. For example, the following description will be given centering upon a mobile communication system serving as a 3GPP LTE or LTE-A system, but the present invention is not limited thereto and the remaining parts of the present invention other than unique characteristics of the 3GPP LTE or LTE-A system are applicable to other mobile communication systems.

In some cases, in order to prevent ambiguity of the concepts of the present invention, conventional devices or apparatuses well known to those skilled in the art will be omitted and be denoted in the form of a block diagram on the basis of important functions of the present invention. Wherever possible, the same reference numbers will be used throughout the drawings to refer to the same or like parts.

In the following description, a terminal may refer to a mobile or fixed user equipment (UE), for example, a user equipment (UE), a mobile station (MS) and the like. Also, the base station (BS) may refer to an arbitrary node of a network end which communicates with the above terminal, and may include an eNode B (eNB), a Node B (Node-B), an access point (AP) and the like. The term “UE” for use in the present invention may also be referred to as a Machine to Machine (M2M) terminal or a Human Type Communication (HTC) terminal.

In a mobile communication system, the UE may receive information from the base station (BS) via a downlink, and may transmit information via an uplink. The information that is transmitted and received to and from the UE includes data and a variety of control information. A variety of physical channels are used according to categories of transmission (Tx) and reception (Rx) information of the UE.

The following embodiments of the present invention can be applied to a variety of wireless access technologies, for example, CDMA (Code Division Multiple Access), FDMA (Frequency Division Multiple Access), TDMA (Time Division Multiple Access), OFDMA (Orthogonal Frequency Division Multiple Access), SC-FDMA (Single Carrier Frequency Division Multiple Access), and the like. CDMA may be embodied through wireless (or radio) technology such as UTRA (Universal Terrestrial Radio Access) or CDMA2000. TDMA may be embodied through wireless (or radio) technology such as GSM (Global System for Mobile communication)/GPRS (General Packet Radio Service)/EDGE (Enhanced Data Rates for GSM Evolution). OFDMA may be embodied through wireless (or radio) technology such as Institute of Electrical and Electronics Engineers (IEEE) 802.11 (Wi-Fi), IEEE 802.16 (WiMAX), IEEE 802-20, and E-UTRA (Evolved UTRA). UTRA is a part of UMTS (Universal Mobile Telecommunications System). 3GPP (3rd Generation Partnership Project) LTE (long term evolution) is a part of E-UMTS (Evolved UMTS), which uses E-UTRA. 3GPP LTE employs OFDMA in downlink and employs SC-FDMA in uplink. LTE-Advanced (LTE-A) is an evolved version of 3GPP LTE.

It should be noted that specific terms disclosed in the present invention are proposed for convenience of description and better understanding of the present invention, and the use of these specific terms may be changed to other formats within the technical scope or spirit of the present invention.

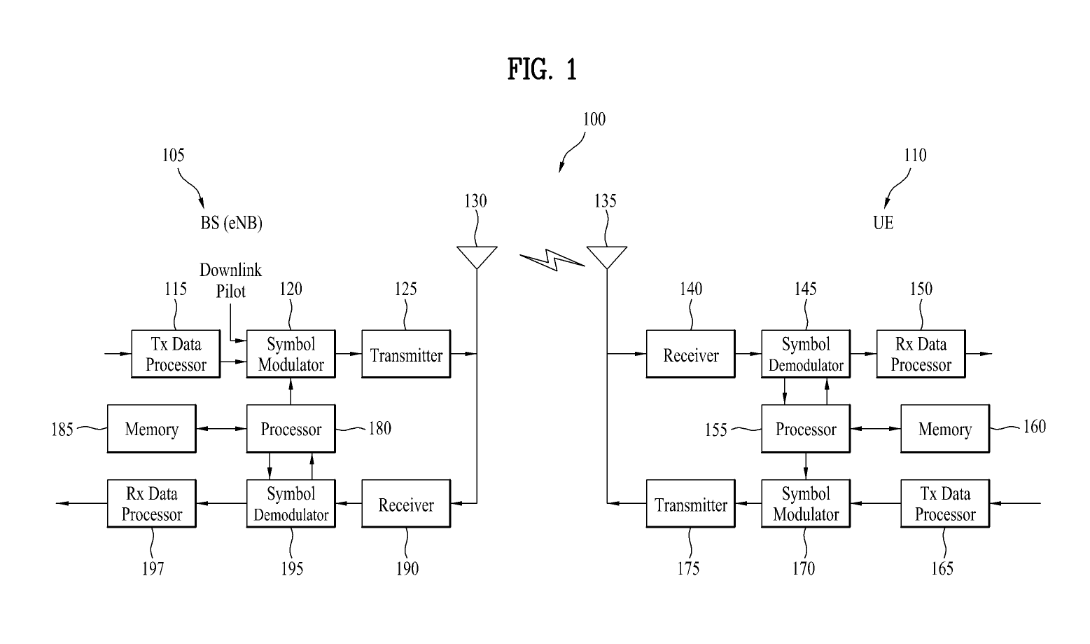

FIG. 1 is a block diagram illustrating a base station (BS) 105 and a user equipment (UE) 110 for use in a wireless communication system 100 according to the present invention.

Although FIG. 1 shows one UE 105 and one UE 110 (including a D2D UE) for brief description of the wireless communication system 100, it should be noted that the wireless communication system 100 may further include one or more BSs and/or one or more UEs.

Referring to FIG. 1, the BS 105 may include a transmission (Tx) data processor 115, a symbol modulator 120, a transmitter 125, a transmission/reception antenna 130, a processor 180, a memory 185, a receiver 190, a symbol demodulator 195, and a reception (Rx) data processor 197. The UE 110 may include a Tx data processor 165, a symbol modulator 170, a transmitter 175, a transmission/reception antenna 135, a processor 155, a memory 160, a receiver 140, a symbol demodulator 155, and an Rx data processor 150. In FIG. 1, although one antenna 130 is used for the BS 105 and one antenna 135 is used for the UE 110, each of the BS 105 and the UE 110 may also include a plurality of antennas as necessary. Therefore, the BS 105 and the UE 110 according to the present invention support a Multiple Input Multiple Output (MIMO) system. The BS 105 according to the present invention can support both a Single User-MIMO (SU-MIMO) scheme and a Multi User-MIMO (MU-MIMO) scheme.

In downlink, the Tx data processor 115 receives traffic data, formats the received traffic data, codes the formatted traffic data, interleaves the coded traffic data, and modulates the interleaved data (or performs symbol mapping upon the interleaved data), such that it provides modulation symbols (i.e., data symbols). The symbol modulator 120 receives and processes the data symbols and pilot symbols, such that it provides a stream of symbols.

The symbol modulator 120 multiplexes data and pilot symbols, and transmits the multiplexed data and pilot symbols to the transmitter 125. In this case, each transmission (Tx) symbol may be a data symbol, a pilot symbol, or a value of a zero signal (null signal). In each symbol period, pilot symbols may be successively transmitted during each symbol period. The pilot symbols may be an FDM symbol, an OFDM symbol, a Time Division Multiplexing (TDM) symbol, or a Code Division Multiplexing (CDM) symbol.

The transmitter 125 receives a stream of symbols, converts the received symbols into one or more analog signals, and additionally adjusts the one or more analog signals (e.g., amplification, filtering, and frequency upconversion of the analog signals), such that it generates a downlink signal appropriate for data transmission through an RF channel. Subsequently, the downlink signal is transmitted to the UE through the antenna 130.

Configuration of the UE 110 will hereinafter be described in detail. The antenna 135 of the UE 110 receives a DL signal from the BS 105, and transmits the DL signal to the receiver 140. The receiver 140 performs adjustment (e.g., filtering, amplification, and frequency downconversion) of the received DL signal, and digitizes the adjusted signal to obtain samples. The symbol demodulator 145 demodulates the received pilot symbols, and provides the demodulated result to the processor 155 to perform channel estimation.

The symbol demodulator 145 receives a frequency response estimation value for downlink from the processor 155, demodulates the received data symbols, obtains data symbol estimation values (indicating estimation values of the transmitted data symbols), and provides the data symbol estimation values to the Rx data processor 150. The Rx data processor 150 performs demodulation (i.e., symbol-demapping) of data symbol estimation values, deinterleaves the demodulated result, decodes the deinterleaved result, and recovers the transmitted traffic data.

The processing of the symbol demodulator 145 and the Rx data processor 150 is complementary to that of the symbol modulator 120 and the Tx data processor 115 in the BS 205.

The Tx data processor 165 of the UE 110 processes traffic data in uplink, and provides data symbols. The symbol modulator 170 receives and multiplexes data symbols, and modulates the multiplexed data symbols, such that it can provide a stream of symbols to the transmitter 175. The transmitter 175 receives and processes the stream of symbols to generate an uplink (UL) signal, and the UL signal is transmitted to the BS 105 through the antenna 135.

The BS 105 receives the UL signal from the UE 110 through the antenna 130. The receiver processes the received UL signal to obtain samples. Subsequently, the symbol demodulator 195 processes the symbols, and provides pilot symbols and data symbol estimation values received via uplink. The Rx data processor 197 processes the data symbol estimation value, and recovers traffic data received from the UE 110.

A processor 155 or 180 of the UE 110 or the BS 105 commands or indicates operations of the UE 110 or the BS 105. For example, the processor 155 or 180 of the UE 110 or the BS 105 controls, adjusts, and manages operations of the UE 210 or the BS 105. Each processor 155 or 180 may be connected to a memory unit 160 or 185 for storing program code and data. The memory 160 or 185 is connected to the processor 155 or 180, such that it can store the operating system, applications, and general files.

The processor 155 or 180 may also be referred to as a controller, a microcontroller), a microprocessor, a microcomputer, etc. In the meantime, the processor 155 or 180 may be implemented by various means, for example, hardware, firmware, software, or a combination thereof. In a hardware configuration, methods according to the embodiments of the present invention may be implemented by the processor 155 or 180, for example, one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, etc.

In a firmware or software configuration, methods according to the embodiments of the present invention may be implemented in the form of modules, procedures, functions, etc. which perform the above-described functions or operations. Firmware or software implemented in the present invention may be contained in the processor 155 or 180 or the memory unit 160 or 185, such that it can be driven by the processor 155 or 180.

Radio interface protocol layers among the UE 110, the BS 105, and a wireless communication system (i.e., network) can be classified into a first layer (L1 layer), a second layer (L2 layer) and a third layer (L3 layer) on the basis of the lower three layers of the Open System Interconnection (OSI) reference model widely known in communication systems. A physical layer belonging to the first layer (L1) provides an information transfer service through a physical channel. A Radio Resource Control (RRC) layer belonging to the third layer (L3) controls radio resources between the UE and the network. The UE 110 and the BS 105 may exchange RRC messages with each other through the wireless communication network and the RRC layer.

While the UE processor 155 enables the UE 110 to receive signals and can process other signals and data, and the BS processor 180 enables the BS 105 to transmit signals and can process other signals and data, the processors 155 and 180 will not be specially mentioned in the following description. Although the processors 155 and 180 are not specially mentioned in the following description, it should be noted that the processors 155 and 180 can process not only data transmission/reception functions but also other operations such as data processing and control:

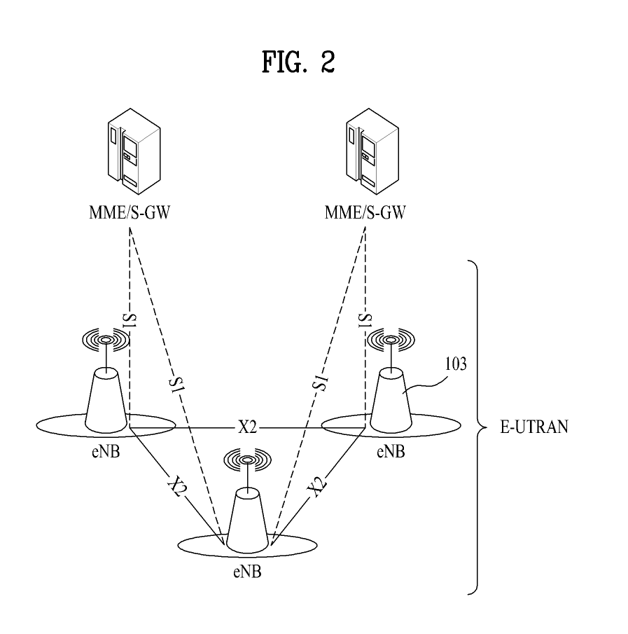

FIG. 2 shows an exemplary overall architecture of the 3GPP LTE system.

Referring to FIG. 2, The E-UTRAN may include eNBs, providing the E-UTRA user plane (PDCP/RLC/MAC/PHY) and control plane (RRC) protocol terminations towards the UE. The eNBs are interconnected with each other by means of the X2 interface. The eNBs are also connected by means of the S1 interface to the EPC (Evolved Packet Core), more specifically to the MME (Mobility Management Entity) by means of the S1-MME interface and to the Serving Gateway (S-GW) by means of the S1-U interface. The S1 interface supports a many-to-many relation between MMEs/Serving Gateways and eNBs.

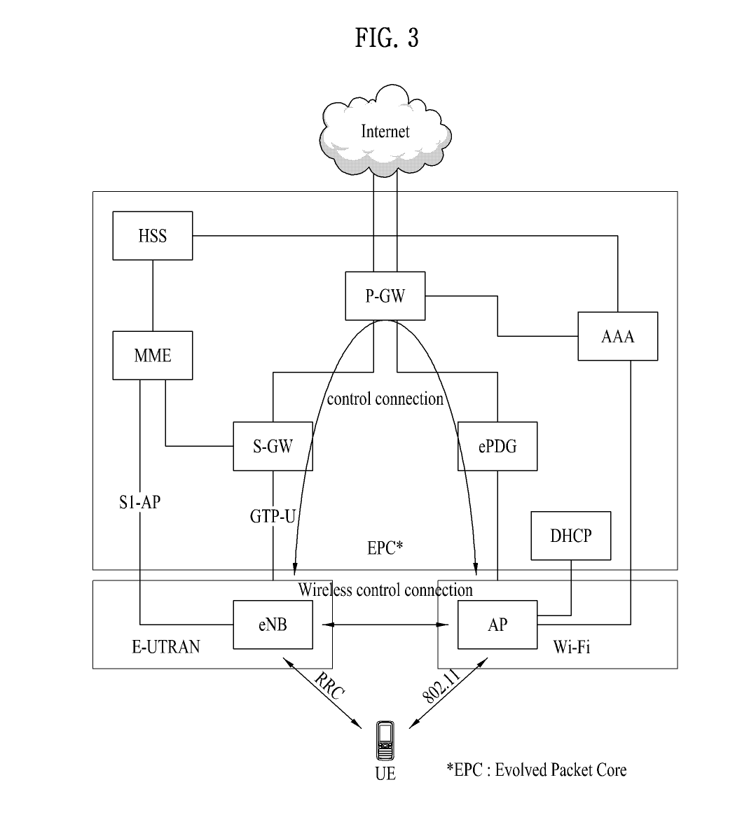

FIG. 3 is a conceptual diagram illustrating a network structure for explaining an interworking structure between a first communication system (e.g., LTE system) and a second communication system (e.g., Wi-Fi system).

As can be seen from the network structure of FIG. 13, a backhaul control connection may be present between an AP and an eNB through a backbone network (e.g., P-GW or Evolved Packet Core (EPC)), or a wireless control connection may be present between the AP and the eNB. For peak throughput and data traffic offloading, the UE may simultaneously support a first communication system (or a first communication network) configured to use a first wireless communication scheme and a second communication system (or a second communication network) configured to use a second wireless communication scheme through interworking between a plurality of communication networks. In this case, the first communication network may be referred to as a primary network, and the first communication system may be referred to as a primary system. The second communication network may be referred to as a secondary network, and the second communication system may be referred to as a secondary system. For example, the UE may be configured to simultaneously support an LTE (or LTE-A) system and a Wi-Fi system (Near Field Communication (NFC) system such as WLAN/802.11). The above-mentioned UE may also be referred to as a multi-system capability UE.

In the network structure shown in FIG. 13, the primary system has wider coverage, and may be a network for transmitting control information. WiMAX or LTE (LTE-A) system may be used as an example of the primary system. Meanwhile, a secondary system has a network having small coverage, and may be a system for data transmission. For example, the secondary system may be a WLAN or Wi-Fi system.

The present invention assumes the following items, and a detailed description thereof will hereinafter be described in detail.

It is assumed that an entity for managing interworking is an entity contained in a cellular network, and an interworking function is implemented in the following three entities.

c-NB—Reuse existing entity

Mobility Management Entity (MME)—Reuse existing entity

InterWorking Management Entity (IWME)—Define new entity

The interworking function is associated with an interworking-related procedure between the eNB and the UE or between the eNB and the AP, an entity for managing interworking may store and/or manage AP information. The eNB, MME, and/or IWME may store/manage information of APs covered thereby. It is assumed that the relationship between the access point (AP) of the secondary system (e.g., Wi-Fi) and the cNB (or MME or IWME) acting as an AP of the primary system (e.g., LTE or WiMAX) is denoted by control connection.

Method 1: Wired Control Connection

New interface is established through a backbone network.

Method 2: Wireless Control Connection

In a technical idea of the present invention, an AP having an air interface relationship with the eNB is referred to as an eAP. That is, the eAP must support not only 802.11 MAC/PHY but also the LTE protocol stack for communication with the eNB, may serve as the same role as an LTE UE in association with the eNB, and may communicate with the eNB.

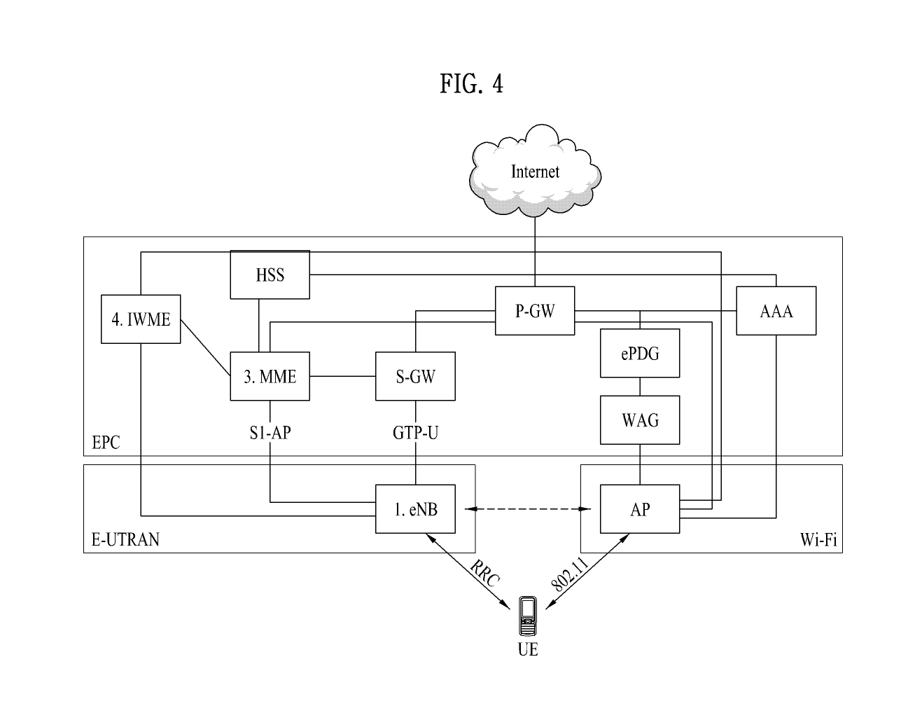

FIG. 4 is a conceptual diagram illustrating a network structure of Wi-Fi-Cellular interworking according to embodiments of the present invention.

According to technology of the present invention, in order to enable a dual-mode UE to more efficiently use a Wi-Fi cellular convergence network under the environment in which there is a UE capable of simultaneously transmitting/receiving a Wi-Fi network and a cellular network, a dual mode UE, the cellular network can manage information of the AP according to the following four methods (Method 1˜Method 4).

Method 1: Use of Air Interface Between eNB and AP

In Method 1, the eNB may control an AP using a wireless control connection to the AP in a similar way to a general UE.

Method 2: Use of Backhaul Interface Between eNB and AP

In Method 2, the eNB may control an AP using a wired control connection to the AP. d

Method 3: Use of Control Interface Between MME and AP

In Method 3, an AP may be controlled using control connection between MME and AP (i.e., secondary system).

Method 4: Use of Control Interface Between IWME and AP

In Method 4, an AP can be controlled using control connection between IWME and AP (i.e., secondary system).

The present invention proposes the cellular-coordinated AP power control scheme. In addition, for interference mitigation between APs and energy efficiency of the system, the present invention will propose a procedure for AP transmit power control based on the cellular network.

A Method of Scanning WIFI Network for a User Equipment in an Idle Mode

The first and second method for scanning WIFI of idle mode user equipment is described as follows.

The first method is started according to an indication of network. For example, the WIFI scanning may be started by WIFI scan request message which is transmitted from the network. A trigger condition for WIFI scan result reporting could be defined. The network indicates a WIFI network connection based on the WIFI scan result which is received from the user equipment.

In the second method, the user equipment autonomously starts the WIFI scanning. A trigger condition for WIFI scan result reporting could be defined. For example, the WIFI scanning may be started if the predetermined data which is preferred by the user equipment is produced. A user equipment of a connected mode transmits scanning result to the network according to a trigger condition for the WIFI network connection. A user equipment of idle mode reports scan result to the network to be indicated the connecting to the WIFI. That is, a conversion from the idle mode to the connected mode is necessary.

Further, a method for starting WIFI scanning without performing the conversion from the idle mode to the connected mode is requested. When the user equipment produces predetermined uplink data and determines that the uplink data should be transmitted through the WIFI, the user equipment could start WIFI network scanning without a connection establishment to a cellular network. For example, the user equipment could start the WIFI scanning based on a result of comparing signal strength of the cellular network and signal strength of WIFI network (a threshold for the comparing could be defined). Also, the user equipment could start the WIFI scanning according to a preference of scanned APs. The user equipment of the idle state turns on a WIFI transceiver and scanning the WIFI network, if the predetermined uplink data is produced. After the scanning, the user equipment determines the connection to the WIFI network based on pre-received conditions or predetermined conditions.

A Method of Connecting to WIFI Network for a User Equipment in an Idle Mode (UL Data, UE Triggered WIFI Attach)

The user equipment performs an association to the WIFI network when the user equipment determines the connection to the WIFI network.

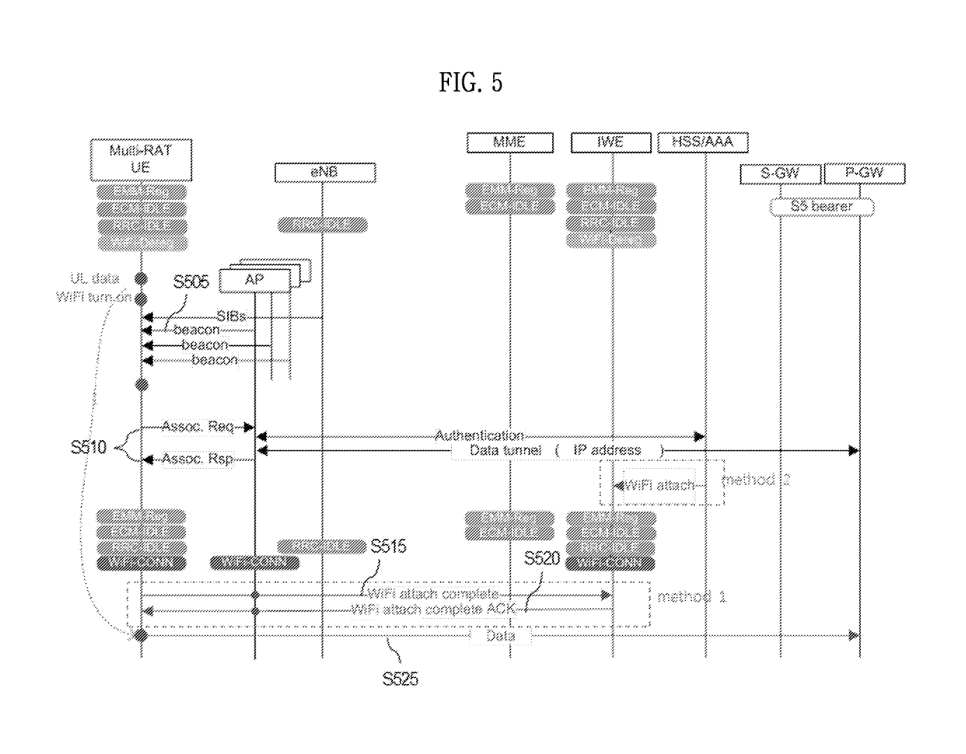

FIG. 5 is a conceptual diagram illustrating the method of connecting to WIFI network for a user equipment in an idle mode (UL data, UE triggered WIFI attach).

Referring to the FIG. 5, when uplink data for the user equipment in an idle mode is generated, the WIFI transceiver of the UE may be turned on.

The Multi-RAT UE of an idle mode receives beacon signal which is broadcasted from at least one AP (S505). After that, association with a particular AP is performed. After establishing association, the Multi-RAT UE operates in a connected state (S510).

The Multi-RAT UE is changed to a connected mode in a WIFI network, while maintaining an idle mode in a cellular mode. After the WIFI connection is successfully completed, the MME could newly register the position of the Multi-RAT UE. That is, the position of the Multi-RAT UE could be more accurately managed.

The Multi-RAT UE completing the WiFi attach transmits a WIFI attach completion message to the IWE (S515). Also, the IWE transmits a ACK message (e.g., WiFi attack complete ACK message) to a Multi-RAT UE in idle mode in response to the WIFI attach completion message (S520). That is, after the association, the UE may transmits the WIFI attach completion message to the IWE. Further, whether the WIFI network is connected is confirmed through HISS/AAA authentication.

Then, the Multi-RAT UE could transmit the uplink data the P-GW (S525).

A Method of Connecting to WIFI Network for a User Equipment in an Idle Mode (DL Data, Network Triggered WIFI Attach)

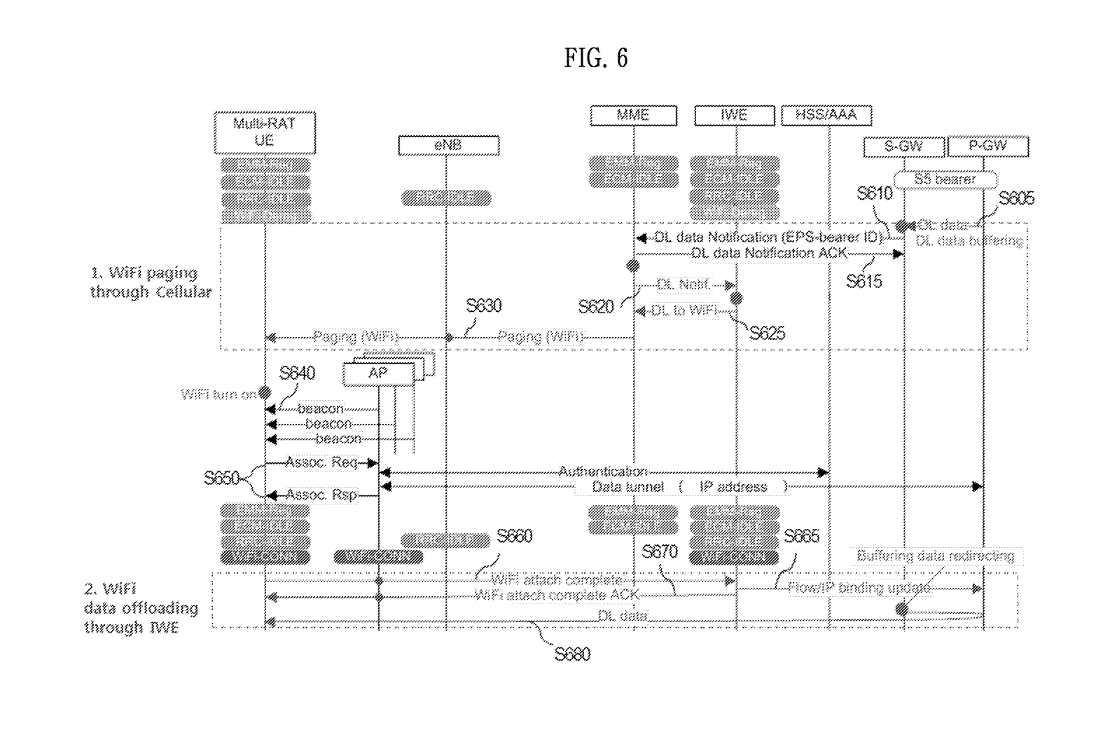

FIG. 6 is a conceptual diagram illustrating the method of connecting to WIFI network for a user equipment in an idle mode.

Referring to the FIG. 6, when downlink data for the user equipment in an idle mode is arrived at a buffer of the network, the user equipment could transmits data through a secondary system (i.e., WLAN) without a cellular network connection establishment.

When downlink data for a Multi-RAT UE in idle mode is arrived in a buffer (S605), a S-GW informs MME of that using a DL data Notification message (EPS bearer ID included) (S610). The MME transmits an acknowledgment message (e.g., DL data Notification ACK message) to the S-GW (S615). The MME may transmit a message indicating presence of downlink data to a IWE (inter working entity) before producing data bearer (S620). When the IWE determines a transmission of the downlink data through the WIFI, the IWE could transmit a message requesting WIFI reconnection (e.g., DL to WiFi request message) (S625).

Then, the MME transmits an indication message to all eNB belonging to the tracking area to transmit a WIFI paging message (S630).

The eNB received the indication message transmits the WIFI paging message through paging channel (PCH) (S630).

If a new WIFI paging message is defined, the new WIFI paging message may be transmitted. If using the existing paging message, a parameter indicating WiFi paging may be transmitted.

The cellular network may start a WiFi attach/awake deadline timer from the time the message is transmitted. Also, the Multi-RAT UE may start a WiFi attach/awake deadline timer from the time the message is received.

The Multi-RAT UE, which periodically wakes up and checks the PCH, turns on the WIFI transceiver, if the Multi-RAT UE receives the WIFI paging message. That is, the Multi-RAT UE of an idle mode receives beacon signal which is broadcasted from at least one AP (S640). After that, association with a particular AP is performed. After establishing association, the Multi-RAT UE operates in a connected state (S650).

The Multi-RAT UE is changed to a connected mode in a WIFI network, while maintaining an idle mode in a cellular mode. After the WIFI connection is successfully completed, the MME could newly register the position of the Multi-RAT UE. That is, the position of the Multi-RAT UE could be more accurately managed.

The Multi-RAT UE completing the WiFi attach transmits a WIFI attach completion message to the IWE (S660). The IWE transmits information related to Flow/IP binding update to the P-GW (S665). Also, the IWE transmits a ACK message (e.g., WiFi attack complete ACK message) to a Multi-RAT UE in idle mode in response to the WIFI attach completion message (S670).

The S-GW performs data off-loading through the IWE by redirecting the buffered data. That is, the Multi-RAT UE receives downlink data of the cellular network through a WIFI AP. That is, the IWE, which recognize that the WIFI connection is successfully performed, transmits a message to transmit the downlink data through the connected WIFI network. The Multi-RAT UE may receive the downlink data through the connected WIFI network.

As described above, if downlink data for Multi-RAT UE in an idle state of a cellular network is arrived at buffer, the downlink data could be transmitted through a secondary system (e.g., WIFI) without a cellular connection establishment.

If the WIFI attach/awake complete message is not received until the time is expired, the MME transmits a message to eNB to transmit a paging message. That is, cellular paging procedures are requested.

a Method of Connecting to WIFI Network for a User Equipment in WIFI Power Saving Mode

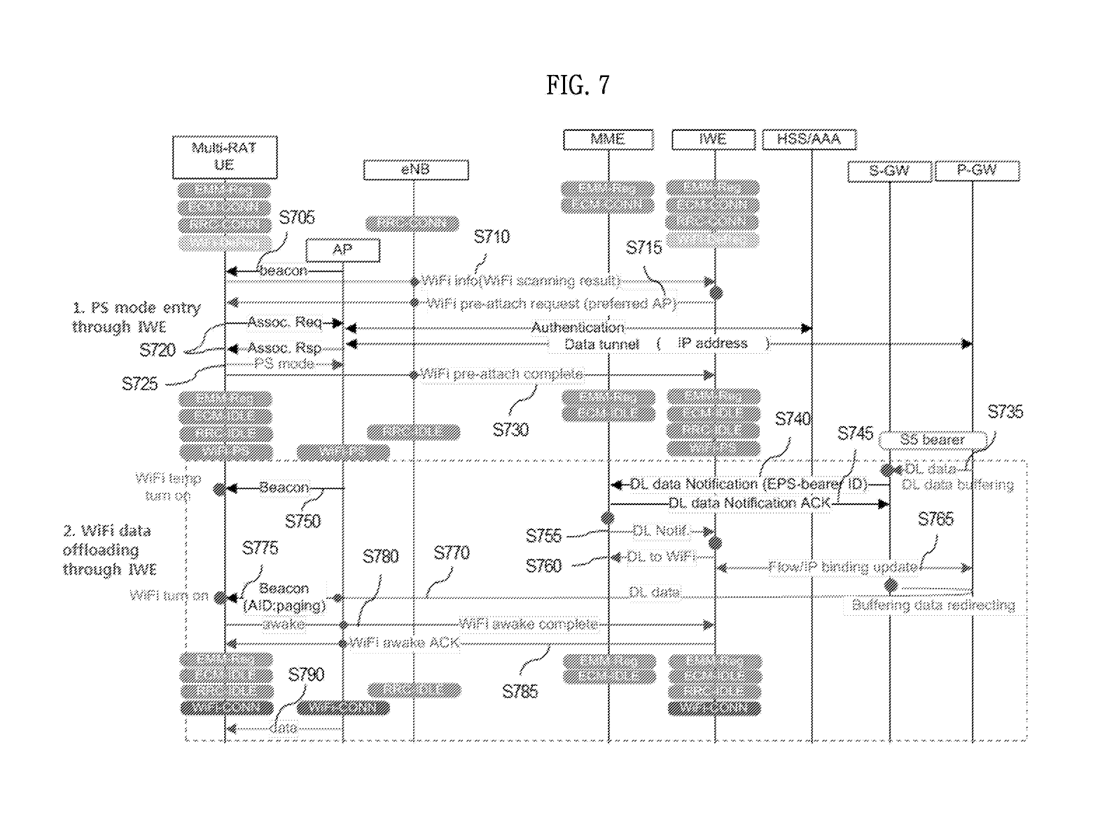

FIG. 7 is a conceptual diagram illustrating the method of connecting to WIFI network for a user equipment in the WIFI power saving mode.

As shown in FIG. 7, the Multi-RAT UE in an idle mode may receive beacon signals from at least one AP (S705). The Multi-RAT UE performs WIFI scanning for detecting the AP, and the Multi-RAT UE transmits a WIFI scanning result to the cellular network (e.g., IWE) (S710). Then, the cellular network (e.g., IWE) may transmits a WIFI pre-attach request message which requests the UE to pre-attach to the preferred AP (S715).

When there is no downlink data which is transmitted to the UE, the cellular network transmits a message requesting the UE to entry the WiFi power saving mode after completion of the pre-attach. The Multi-RAT UE performs association procedures with the AP (S720). The Multi-RAT UE could transmits an indicator (e.g., PM=1) to the AI, the indicator informing the entry of the power saving mode (S725). After the Multi-RAT UE enters the WiFi power saving mode, the UE may transmit a WiFi pre-attach complete message to the IWE (S730).

When the downlink data for the Multi-RAT UE in idle mode arrives in the buffer (S735), the S-GW informs the MME of this using a DL data Notification message (EPS bearer ID included) (S740). The MME transmits a acknowledgment message (e.g., DL data Notification ACK message) to the S-GW (S745). Also, before generating the data bearer, the MME may transmit, to the IWE, a message indicating that there is the downlink data (S755).

The Multi-RAT UE changes to the RRC-IDLE state, and operates in the power saving mode. The UE may turn on the WIFI transceiver, and receive signals periodically broadcasted from the AP (e.g., a beacon signal) (S750). The Multi-RAT UE detects the paging of beacon. If the IWE determines to transmit the downlink data through the WIFI network, the IWE transmits a message requesting WIFI re-connection (e.g. DL to WiFi request message) to the MME (S760).

The IWE performs Flow/IP binding update procedures with the P-GW (S765). The S-GW redirects the buffered data, and transmits downlink data to the AP (S770). The Multi-RAT UE in idle mode receives a beacon signal (included AID, paging), and enters in awake mode (S775). The UE transmits WiFi awake completion message through the AP to the IWE (S780). The Multi-RAT UE in idle mode may receive a acknowledgment message (e.g., WiFi awake ACK message) from the IWE (S785).

The UE in a WIFI awake mode could receive the off-loaded downlink data from the AP (S790).

A Method of Cellular Paging Based on WIFI Location

In this method, the Multi-RAT UE is in a WIFI registration mode. That is, the UE already performed the association or pre-association with the WIFI network. In this case, the IWE could find the location of the UE, more accurately, and know that the UE in the specific cell. The MME could manage the location of the UE in an idle mode as one cell (eNB), not TA (one or more cells). When the downlink data is arrived, the MME could transmits a paging request message to only the eNB corresponding to the AP to which the UE is connected.

If the MME do not receive a connection request message from the UE for certain time, the MME may transmit the paging request message to one or more eNB of the tracking area.

The first method for managing the location of the UE is periodically performed by the MME. In this case, the IWE updates the location of the UE whenever the UE connect to the WIFI network.

Even though the UE is changed to the idle mode, the MME should update the location of the UE from the IWE.

If the MME receives a DL data notification from the S-GW, the MME may request certain eNB to transmit the paging message based on the WIFI location of the UE. Also, the MME could transmit, to the IWE, a message including whether the DL data should be transmitted via the WIFI network or the cellular network. When the IWE request the MME to transmit the DL data via cellular network, the MME transmits the paging request message to only the certain eNB to which the UE is connected.

If the UE is released from the WIFI connection, the MME performs the paging procedures based on the tracking area. That is, the MME does no transmit the paging request message to the certain eNB, but one or more eNB corresponding to the tracking area.

The second method for managing the location of the UE is performed only when the MME receives DL data for the UE in an idle mode.

When the MME receives the DL data for the UE, the MME checks whether the UE is a Multi-RAT UE. Then, the MME informs the IWE that the DL data is arrived, and requests the WIFI location of the UE to the IWE.

When the IWE determines to transmits the DL data via cellular network, the IWE transmits, to the IWE, cell information indicating the certain eNB to which the UE is connected. The MME transmits the paging request message only to the certain cNB to which the UE is connected.

The DL data notification message and the WIFI location request message could be defined respectively.

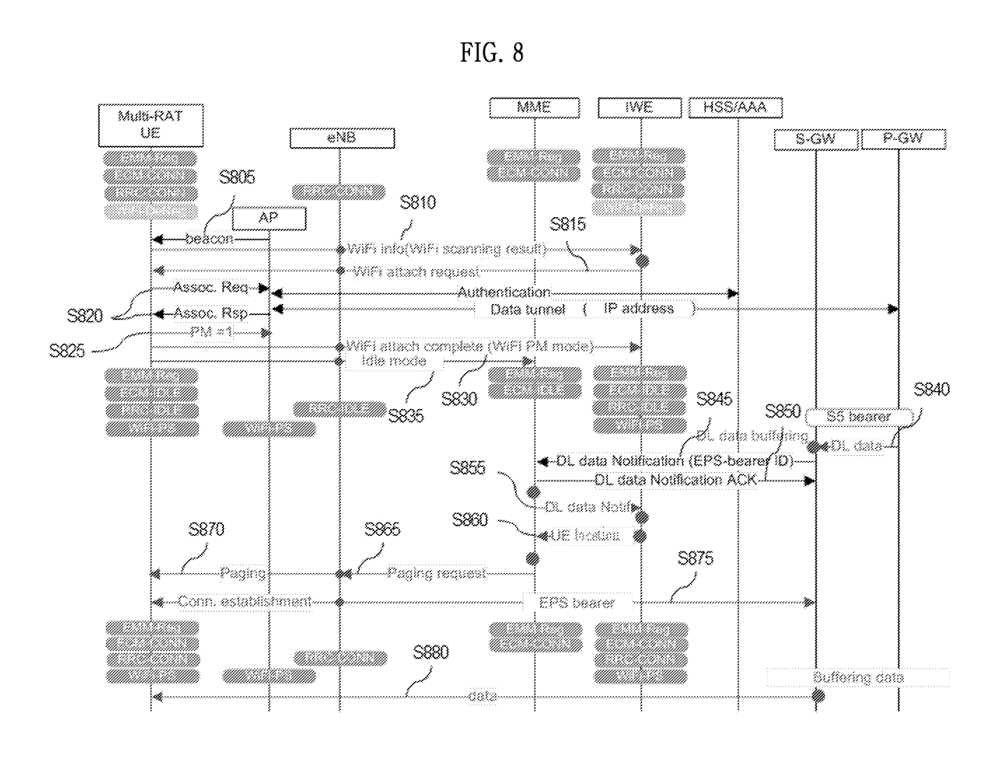

FIG. 8 is a conceptual diagram illustrating the method of cellular paging based on the WIFI location.

The FIG. 8 is based on the WIFI power saving mode, but the features of FIG. 8 could be adapted to active mode or newly defined power saving mode.

As shown in FIG. 8, the Multi-RAT UE in an idle mode may receive beacon signals from at least one AP (S805). The Multi-RAT UE performs WIFI scanning for detecting the AP, and the Multi-RAT UE transmits a WIFI scanning result to the cellular network (e.g., IWE) (S810). Then, the cellular network (e.g., IWE) may transmits a WIFI attach request message which requests the UE to attach to the preferred AP (S815).

When there is no downlink data which is transmitted to the UE, the cellular network transmits a message requesting the UE to entry the WiFi power saving mode after completion of the attach. The Multi-RAT UE performs association procedures with the AP (S820). The Multi-RAT UE could transmits a indicator (e.g., PM=1) to the AP, the indicator informing the entry of the power saving mode (S825). After the Multi-RAT UE enters the WiFi power saving mode, the UE may transmit a WiFi attach complete message to the IWE (S830).

Then, the Multi-RAT UE is changed to the cellular idle mode. That is, the UE is in the RRC-idle state (S835).

When the downlink data for the Multi-RAT UE in idle mode arrives in the buffer (S840), the S-GW informs the MME of this using a DL data Notification message (EPS bearer ID) included) (S845). The MME transmits a acknowledgment message (e.g., DL data Notification ACK message) to the S-GW (5850). Also, before generating the data bearer, the MME may transmit, to the IWE, a message indicating that there is the downlink data (S855).

If the IWE determines to transmit the downlink data through the cellular network, the IWE transmits, to the MME, a message including the WIFI location (S860).

Then, the MME transmits the paging request message only to the certain eNB based on the WIFI location (S865). The certain eNB performs the paging procedures (S870).

The Multi-RAT UE establishes the connection with the eNB, and EPS bearer is generated (S875). Finally, the UE could receive the buffered downlink data from the S-GW (S880).

Exemplary embodiments described hereinbelow are combinations of elements and features of the present invention. The elements or features may be considered selective unless mentioned otherwise. Each element or feature may be practiced without being combined with other elements or features. Further, an embodiment of the present invention may be constructed by combining parts of the elements and/or features. Operation orders described in embodiments of the present invention may be rearranged. Some constructions of any one embodiment may be included in another embodiment and may be replaced with corresponding constructions of another embodiment. Also, it will be obvious to those skilled in the art that claims that are not explicitly cited in the appended claims may be presented in combination as an exemplary embodiment of the present invention or included as a new claim by subsequent amendment after the application is filed.

It will be apparent to those skilled in the art that the present invention can be embodied in other specific forms without departing from the spirit and essential characteristics of the invention. Thus, the above embodiments are to be considered in all respects as illustrative and not restrictive. The scope of the invention should be determined by reasonable interpretation f the appended claims and all changes within the equivalent scope of the invention are within the scope of the invention.

### [Mode for Invention]

Various embodiments have been described in the best mode for carrying out the invention.

### INDUSTRIAL APPLICABILITY

The present invention is applicable to a wireless communication apparatus such as a UE, a relay or a BS.

1. A method for paging based on location information of a user equipment connected to a first communication system in a convergence network of a plurality of communication systems, the method performed by a MME (Mobility Management Entity) of a second communication system and comprising:
receiving, from a interworking entity of the second communication system, the location information of the user equipment which is in an idle mode with the second communication system; and
transmitting, to a first cell of the second communication system, a paging request message,
wherein the first cell is selected from among a plurality of cells in a tracking area of the second communication system based on the location information.

2. The method of claim 1, further comprising:
transmitting, to the plurality of cells in the tracking area of the second communication system, the paging request message when a connection request message is not received from the user equipment in a reference time.

3. The method of claim 1, wherein the location information is received whenever the user equipment is connected to the first communication system.

4. The method of claim 1, wherein the location information is received when the MME receives a downlink notification message.

5. The method of claim 1, wherein the location information is determined based on a geological location of a AP (access point) of the first communication system to which the user equipment is connected.

6. The method of claim 1, wherein the first communication system is a WLAN (wireless LAN) network system, and the second communication system is a cellular system.

7. The method of claim 1, wherein the interworking entity is a IWME (InterWorking Management Entity) or a eNode B.

8. A apparatus for paging based on location information of a user equipment connected to a first communication system in a convergence network of a plurality of communication systems, the apparatus comprising:
a RF (Radio Frequency) module,
a processor which is configured to:
receive, from a interworking entity of a second communication system, the location information of the user equipment which is in an idle mode with the second communication system; and
transmit, to a first cell of the second communication system, a paging request message,
wherein the first cell is selected from among a plurality of cells in a tracking area of the second communication system based on the location information.

9. The apparatus of claim 8, the processor is further configured to:
transmit, to the plurality of cells in the tracking area of the second communication system, the paging request message when a connection request message is not received from the user equipment in a reference time.

10. The apparatus of claim 8, wherein the location information is received whenever the user equipment is connected to the first communication system.

11. The apparatus of claim 8, wherein the location information is received when the MME receives a downlink notification message.

12. The apparatus of claim 8, wherein the location information is determined based on a geological location of a AP (access point) of the first communication system to which the user equipment is connected.

13. The apparatus of claim 8, wherein the first communication system is a WLAN (wireless LAN) network system, and the second communication system is a cellular system.

14. The apparatus of claim 8, wherein the interworking entity is a IWME (InterWorking Management Entity) or a eNode B.
